(19) United States
(12) Patent Application Publication
(10) Pub. No.: US 2006/0012914 A1
(43) Pub. Date: Jan. 19, 2006

(54) Thin film magnetic head, head gimbals assembly, head arm assembly, magnetic recording apparatus, and method of manufacturing thin film magnetic head

(75) Inventor: Naoto Matono, Saku-shi (JP)

Correspondence Address: OLIFF & BERRIDGE, PLC, P.O. BOX 19928, ALEXANDRIA, VA, 22320, US

(73) Assignee: SAE MAGNETICS (H.K.) LTD., Shatin, N.T. (CN)

(21) Appl. No.: 11/165,202

(22) Filed: Jun. 24, 2005

(30) Foreign Application Priority Data
Jul. 13, 2004 (JP) 2004-206303

(51) Int. Cl. G11B 5/147

(52) U.S. Cl. 360/126

(57) ABSTRACT

The present invention provides a thin film magnetic head capable of assuring stability in recording process. A write shield layer is constructed so as to have a thickness T1 on the side far from an air bearing surface and a thickness T2 larger than the thickness T1 (T2>T1) by projecting to both of the trailing and leading sides on the side close to the air bearing surface. The volume of the write shield layer becomes relatively small in a rear part and becomes relatively large in a front part. Consequently, the area of an exposed face exposed on the air bearing surface becomes sufficiently large and the magnetic volume around the air bearing surface becomes sufficiently large in the front part, and the thermal expansion amount becomes sufficiently small in the rear part. Therefore, a magnetic flux received from the exposed face of the write shield layer becomes less concentrated in the air bearing surface and the write shield layer is resistive to excessively expand by the influence of heat.

### BACKGROUND OF THE INVENTION

1. Field of the Invention

The present invention relates to a thin film magnetic head having at least an inductive magnetic transducer for recording, a head gimbals assembly, a head arm assembly, a magnetic recording apparatus, and a method of manufacturing a thin film magnetic head.

2. Description of the Related Art

In recent years, as the areal density of a magnetic recording medium (hereinbelow, simply called “recording medium”) such as a hard disk improves, improvement in performance of a thin film magnetic head which is mounted on a magnetic recording apparatus (hereinbelow, simply called “recording apparatus”) such as a hard disk drive (HDD) is demanded. Known recording methods of a thin film magnetic head are a longitudinal recording method in which the orientation of a signal magnetic field is set to an in-plane direction (longitudinal direction) of a recording medium and a perpendicular recording method in which the orientation of a signal magnetic field is set to a direction orthogonal to the surface of a recording medium. At present, the longitudinal recording method is widely used. However, when a market trend accompanying improvement in areal density is considered, it is assumed that, in place of the longitudinal recording method, the perpendicular recording method will be regarded as a promising method in future for the following reason. The perpendicular recording method has advantages such that high linear recording density can be assured and a recorded recording medium is not easily influenced by thermal fluctuations.

A thin film magnetic head of the perpendicular recording method has, mainly, a thin film coil for generating a magnetic flux, a magnetic pole layer for executing a recording process by emitting the magnetic flux generated by the thin film coil toward a recording medium, and a write shield layer for preventing the magnetic flux emitted from the magnetic pole layer from spreading. The thin film magnetic head is mounted on a recording apparatus, generally as an assembly constructed by supporting the thin film magnetic head by a suspension in a state where it is attached to a magnetic head slider, that is, a head gimbals assembly (HGA), or as an assembly in which the above-described suspension is also supported by an arm, that is, a head arm assembly (HAA). As a thin film magnetic head of this kind, for example, a thin film magnetic head in which a write shield layer is disposed on the trailing side of a magnetic pole layer is known (refer to, for example, Japanese Unexamined Patent Application No. 2001-250204 and European Unexamined Patent Application No. 0360978). By using the thin film magnetic head of this kind, spread of the magnetic flux is prevented by the write shield layer at the time of recording. As a result, the recording track width on a recording medium is properly narrowed and the recording density can be improved.

To assure operation characteristics of the thin film magnetic head of the perpendicular recording method, stability in recording process has to be assured. In the conventional thin film magnetic head, however, stability in recording process is still insufficient mainly due to structural factors. From the viewpoint of assuring the operation characteristics, there is still room for improvement. Therefore, to assure the operation characteristics of the thin film magnetic head of the perpendicular recording method, it is desired to establish a head structure capable of assuring stability in recording process. In this case, particularly, it is also important to establish a manufacturing process capable of easily manufacturing a thin film magnetic head in consideration of mass productivity of the thin film magnetic head.

### SUMMARY OF THE INVENTION

The present invention has been achieved in consideration of such problems and its first object is to provide a thin film magnetic head, a head gimbals assembly, a head arm assembly, and a magnetic recording apparatus capable of assuring stability in recording process.

A second object of the invention is to provide a thin film magnetic head manufacturing method capable of easily manufacturing a thin film magnetic head in which stability of recording process is assured.

A thin film magnetic head according to the invention includes: a thin film coil for generating a magnetic flux; a magnetic pole layer extending rearward from a recording-medium-facing surface which faces a recording medium traveling in a medium travel direction and emitting the magnetic flux generated by the thin film coil toward the recording medium; and a magnetic shield layer extending rearward from the recording-medium-facing surface on the medium travel direction side of the magnetic pole layer so that it is isolated from the magnetic pole layer by a gap layer on the side close to the recording-medium-facing surface, coupled to the magnetic pole layer via a back gap on the side far from the recording-medium-facing surface, having a first thickness on the side far from the recording-medium-facing surface, and having a second thickness larger than the first thickness by projecting in both of the medium travel direction and the direction opposite to the medium travel direction on the side close to the recording-medium-facing surface.

A head gimbals assembly according to the invention includes: a magnetic head slider to which a thin film magnetic head according to the invention is attached; and a suspension supporting the magnetic head slider at its one end.

A head arm assembly according to the invention includes: a magnetic head slider to which the thin film magnetic head of the invention is attached; a suspension supporting the magnetic head slider at its one end; and an arm supporting the other end of the suspension.

A magnetic recording apparatus according to the invention has a recording medium and a head arm assembly, and the head arm assembly includes: a magnetic head slider to which the thin film magnetic head of the invention is attached; a suspension supporting the magnetic head slider at its one end; and an arm supporting the other end of the suspension.

In the thin film magnetic head, head gimbals assembly, head arm assembly, and magnetic recording apparatus according to the invention, a magnetic shield layer is constructed so as to have a first thickness on the side far from a recording-medium-facing surface and a second thickness larger than the first thickness by projecting to both of the medium travel direction side and a side opposite to the medium travel direction side on the side close to the recording-medium-facing surface. The volume of the magnetic shield layer becomes relatively small in a rear part and becomes relatively large in a front part. In this case, the area of an exposed face exposed in the recording-medium-facing surface becomes sufficiently large in the front part of the magnetic shield layer and the magnetic volume around the recording-medium-facing surface becomes sufficiently large, and the thermal expansion amount becomes sufficiently small in the rear part. Therefore, a magnetic flux received from the exposed face of the magnetic shield layer exposed in the recording-medium-facing surface becomes less concentrated around the recording-medium-facing surface, so that occurrence of unintended overwriting of information is suppressed. In addition, the magnetic shield layer is resistive to excessively expand by the influence of heat, so that occurrence of a projection defect is suppressed.

A method of manufacturing a thin film magnetic head according to the invention is a method of manufacturing a thin film magnetic head including: a thin film coil for generating a magnetic flux; a magnetic pole layer extending rearward from a recording-medium-facing surface which faces a recording medium traveling in a medium travel direction and emitting the magnetic flux generated by the thin film coil toward the recording medium; and a magnetic shield layer extending rearward from the recording-medium-facing surface on the medium travel direction side of the magnetic pole layer so that it is isolated from the magnetic pole layer by a gap layer on the side close to the recording-medium-facing surface, and coupled to the magnetic pole layer via a back gap on the side far from the recording-medium-facing surface. The method includes a step of forming the magnetic shield layer so as to have a first thickness on the side far from the recording-medium-facing surface, and have a second thickness larger than the first thickness by projecting in both of the medium travel direction and the direction opposite to the medium travel direction on the side close to the recording-medium-facing surface.

In the thin film magnetic head manufacturing method according to the invention, to form the magnetic shield layer having the first thickness on the side far from the recording-medium-facing surface and the second thickness larger than the first thickness by projecting to both the medium travel direction side and the side opposite to the medium travel direction side on the side close to the recording-medium-facing surface, only the existing thin film processes including the film forming technique, patterning technique, and etching technique are used and a novel and complicated manufacturing process is not used.

In the thin film magnetic head, head gimbals assembly, head arm assembly, and magnetic recording apparatus according to the invention, the magnetic shield layer may include: a first magnetic shield layer part extending rearward from the recording-medium-facing surface to a first position between the recording-medium-facing surface and the back gap while being adjacent to the gap layer; and a second magnetic shield layer part constructed as a member separate from the first magnetic shield layer part and extending rearward from the recording-medium-facing surface to at least the back gap while partially lying on the first magnetic shield layer part in the medium travel direction side of the first magnetic shield layer part. In this case, the first magnetic shield layer part has a third thickness, the second magnetic shield layer part has the first thickness on the side far from the recording-medium-facing surface and a fourth thickness larger than the first thickness by projecting only to the medium travel direction side on the side close to the recording-medium-facing surface, and the second thickness may be specified by the sum of the third thickness and the fourth thickness. The second magnetic shield layer part may include: a second main magnetic shield layer part extending rearward from the recording-medium-facing surface to at least the back gap while partially lying on the first magnetic shield layer part and having the first thickness; and a second sub magnetic shield layer part extending rearward from the recording-medium-facing surface to a second position between the recording-medium-facing surface and the back gap while partially lying on the second main magnetic shield layer part in the medium travel direction side of the second main magnetic shield layer part and having a fifth thickness. The fourth thickness may be specified by the sum of the first thickness and the fifth thickness. Preferably, the second position is rearward of the first position. In particular, the second main magnetic shield layer part and the second sub magnetic shield layer part may be constructed as members different from each other or integrally constructed. In the case where the second main magnetic shield layer part and the second sub magnetic shield layer part are constructed as different members, preferably, the second main magnetic shield layer part is made of a material having resistivity higher than that of the second sub magnetic shield layer part, and the second sub magnetic shield layer part is made of a material having saturated magnetic flux density higher than that of the second main magnetic shield layer part. The magnetic pole layer may emit a magnetic flux for magnetizing the recording medium in a direction orthogonal to the surface of the recording medium.

In the method of manufacturing a thin film magnetic head according to the invention, the step of forming the magnetic shield layer may include the steps of: forming a first magnetic shield layer part extending rearward from the recording-medium-facing surface to a first position between the recording-medium-facing surface and the back gap while being adjacent to the gap layer; and forming a second magnetic shield layer part constructed as a member separate from the first magnetic shield layer part and extending rearward from the recording-medium-facing surface to at least the back gap while partially lying on the first magnetic shield layer part in the medium travel direction side of the first magnetic shield layer part. In this case, the first magnetic shield layer part is formed so as to have a third thickness, the second magnetic shield layer part is formed so as to have the first thickness on the side far from the recording-medium-facing surface and to have a fourth thickness larger than the first thickness by projecting only to the medium travel direction side on the side close to the recording-medium-facing surface, and the second thickness is specified by the sum of the third thickness and the fourth thickness. The process of forming the second magnetic shield layer part may include the steps of: forming a second main magnetic shield layer part constructing a part of the second magnetic shield layer part, extending rearward from the recording-medium-facing surface to at least the back gap while partially lying on the first magnetic shield layer part and having the first thickness; and forming a second sub magnetic shield layer part as another part of the second magnetic shield layer part extending rearward from the recording-medium-facing surface to a second position between the recording-medium-facing surface and the back gap while partially lying on the second main magnetic shield layer part in the medium travel direction side of the second main magnetic shield layer part and so as to have a fifth thickness, and the fourth thickness is specified by the sum of the first thickness and the fifth thickness. Preferably, the second position is rearward of the first position. In particular, the step of forming the magnetic shield layer may include: a first step of forming the first magnetic shield layer part on the gap layer by growing a plating film; a second step of forming the second main magnetic shield layer part so as to extend rearward from the recording-medium-facing surface to at least the back gap while partially lying on the first magnetic shield layer part and having the first thickness as a whole; and a third step of forming the second magnetic shield layer part so as to include the second main magnetic shield layer part and the second sub magnetic shield layer part by forming the second sub magnetic shield layer part as a member different from the second main magnetic shield layer part on the second main magnetic shield layer part by growing a plating film. Alternately, the step of forming the magnetic shield layer may include: a first step of forming the first magnetic shield layer part on the gap layer by growing a plating film; a second step of forming a pre-magnetic shield layer as a preparation layer of the second main magnetic shield layer part so as to extend rearward from the recording-medium-facing surface to at least the back gap while partially lying on the first magnetic shield layer part and having the fourth thickness as a whole; and a third step of forming the second magnetic shield layer part so as to integrally include the second main magnetic shield layer part and the second sub magnetic shield layer part by selectively etching a part on the side far from the recording-medium-facing surface of the pre-magnetic shield layer to the first thickness.

In the thin film magnetic head, head gimbals assembly, head arm assembly, and magnetic recording apparatus according to the invention, based on the structural characteristic that the magnetic shield layer is constructed so as to have a first thickness on the side far from the recording-medium-facing surface and a second thickness larger than the first thickness by projecting both to the medium travel direction side and the side opposite to the medium travel direction side on the side close to the recording-medium-facing surface, a magnetic flux received from the exposed face of the magnetic shield layer exposed in the recording-medium-facing surface becomes less concentrated around the recording-medium-facing surface, so that occurrence of unintended overwriting of information is suppressed. In addition, the magnetic shield layer is resistive to excessively expand by the influence of heat, so that occurrence of a projection defect is suppressed. Therefore, the recording process is stabilized from the viewpoints of both of suppression of occurrence of unintended overwriting of information and suppression of occurrence of a projection defect, so that stability of the recording process can be assured.

In the thin film magnetic head manufacturing method according to the invention, to form the magnetic shield layer having the first thickness on the side far from the recording-medium-facing surface and the second thickness larger than the first thickness by projecting to both the medium travel direction side and the side opposite to the medium travel direction side on the side close to the recording-medium-facing surface, only the existing thin film processes including the film forming technique, patterning technique, and etching technique are used and a novel and complicated manufacturing process is not used. On the basis of such a process characteristic, by using only the existing thin film processes, the thin film magnetic head assuring stability in the recording process can be easily manufactured.

Other and further objects, features and advantages of the invention will appear more fully from the following description.

### BRIEF DESCRIPTION OF THE DRAWINGS

FIG. 1 is a cross section showing a sectional configuration (sectional configuration parallel to a YZ plane) of a thin film magnetic head according to an embodiment of the invention.

FIG. 2 is a cross section showing another sectional configuration (sectional configuration parallel to an XZ plane) of the thin film magnetic head illustrated in FIG. 1.

FIG. 3 is a plan view showing a configuration (configuration seen from the Z-axis direction) of a main part of the thin film magnetic head illustrated in FIG. 1.

FIG. 4 is a cross section showing a sectional configuration (sectional configuration parallel to a YZ plane) of a thin film magnetic head as a first comparative example of the thin film magnetic head according to the embodiment of the invention.

FIG. 5 is a cross section showing a sectional configuration (sectional configuration parallel to a YZ plane) of a thin film magnetic head as a second comparative example of the thin film magnetic head according to the embodiment of the invention.

FIG. 6 is a cross section showing a modification of the configuration of the thin film magnetic head according to the embodiment of the invention.

FIG. 7 is a cross section illustrating a process in a method of manufacturing the thin film magnetic head according to the embodiment of the invention.

FIG. 8 is a cross section illustrating a process subsequent to FIG. 7.

FIG. 9 is a cross section illustrating a process subsequent to FIG. 8.

FIG. 10 is a cross section illustrating a process subsequent to FIG. 9.

FIG. 11 is a cross section illustrating a process in a modification of the method of manufacturing the thin film magnetic head according to the embodiment of the invention.

FIG. 12 is a cross section illustrating a process subsequent to FIG. 11.

FIG. 13 is a cross section illustrating a process subsequent to FIG. 12.

FIG. 14 is a cross section illustrating a process subsequent to FIG. 13.

FIG. 15 is a perspective view showing a configuration of a magnetic recording apparatus on which the thin film magnetic head of the invention is mounted.

FIG. 16 is an enlarged perspective view of a main part of the magnetic recording apparatus illustrated in FIG. 15.

FIG. 17 is a diagram showing the correlation between the configuration of a yoke layer part and a projection amount.

### DETAILED DESCRIPTION OF THE PRFERRED EMBODIMENTS

Embodiments of the invention will now be described in detail hereinbelow with reference to the drawings.

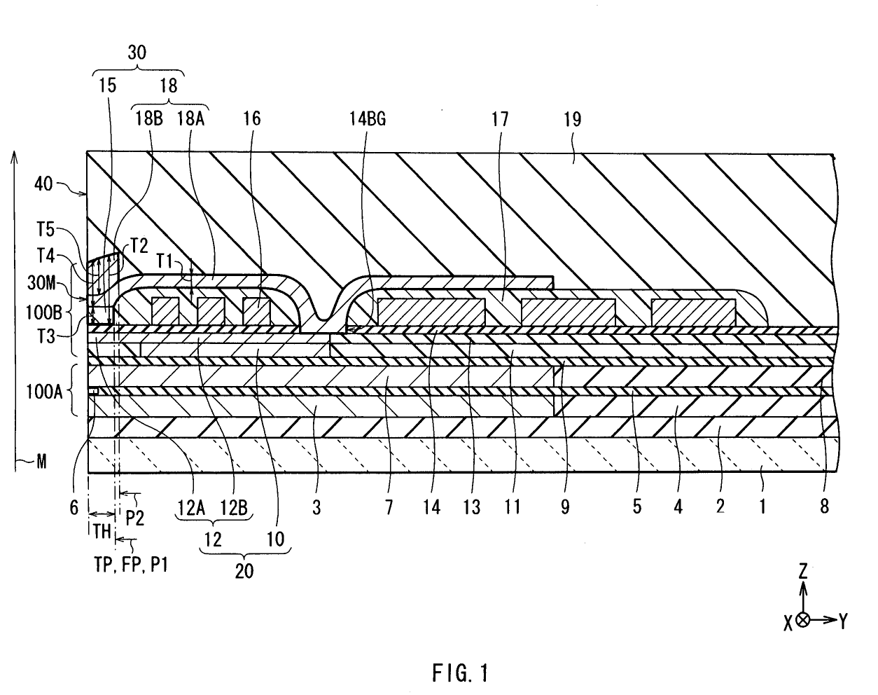

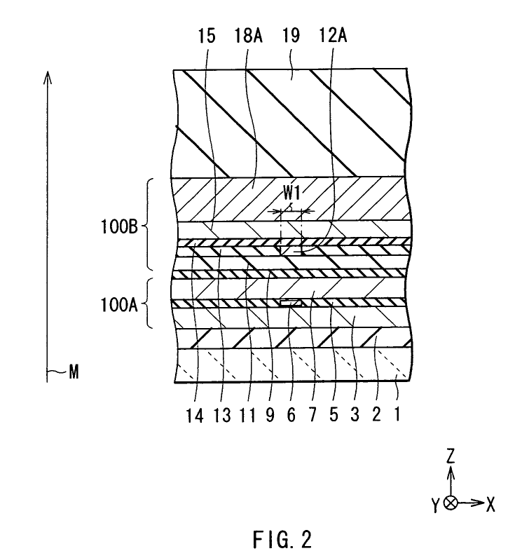

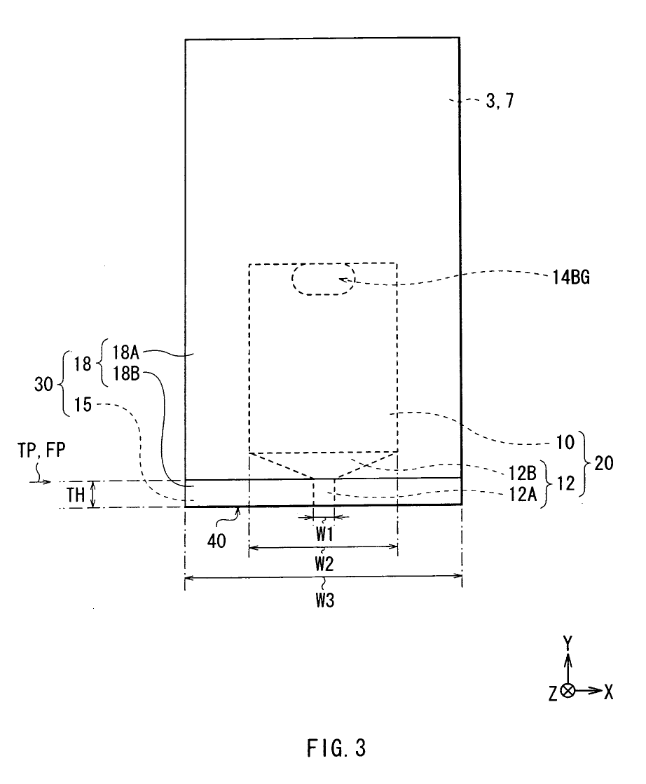

First, the configuration of a thin film magnetic head according to an embodiment of the invention will be described with reference to FIG. 1 to FIG. 3. FIGS. 1 and 2 show sectional configurations of a thin film magnetic head. FIG. 1 shows a sectional configuration perpendicular to the air bearing surface (sectional configuration parallel to the YZ plane). FIG. 2 shows a sectional configuration parallel to the air bearing surface (sectional configuration parallel to the XZ plane). FIG. 3 is a plan view showing the configuration (configuration seen from the Z-axis direction) of the thin film magnetic head illustrated in FIGS. 1 and 2. The up-pointing arrow M shown in FIGS. 1 and 2 indicates the travel direction of a magnetic recording medium (not shown) relative to the thin film magnetic head (medium travel direction M).

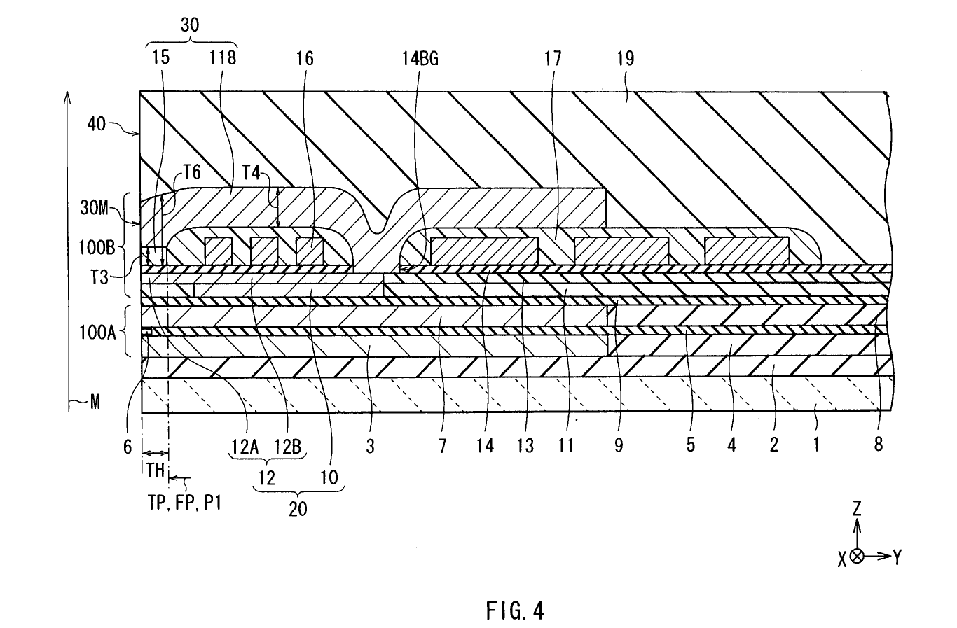

In the following description, the dimension in the X-axis direction shown in FIGS. 1 to 3 will be described as “width”, the dimension in the Y-axis direction will be described as “length”, and the dimension in the Z-axis direction will be described as “thickness”. The side closer to the air bearing surface in the Y-axis direction will be described as “front side” and the side opposite to the forward will be described as “back side”. The description will be similarly used in FIG. 4 and subsequent drawings.

The thin film magnetic head of the embodiment is mounted on a magnetic recording apparatus such as a hard disk drive (HDD) to perform a magnetic process on a magnetic recording medium (hereinbelow, simply called “recording medium”) such as a hard disk traveling in the medium travel direction M. The thin film magnetic head is, for example, a composite head capable of executing both of a recording process and a reproducing process as magnetic processes. As shown in FIG. 1, the thin film magnetic head has a configuration obtained by sequentially stacking, on a substrate 1 made of a ceramic material such as AlTiC (Al₂O₃.TiC), an insulating layer 2 made of a non-magnetic insulating material such as aluminum oxide (Al₂O₃, hereinbelow, simply called “alumina”), a reproducing head portion 100A for executing a reproducing process by using a magneto-resistive (MR) effect, an isolation layer 9 made of a non-magnetic insulating material such as alumina, a recording head portion 100B of a shield type for executing a recording process of a perpendicular recording method, and an overcoat layer 19 made of a non-magnetic insulating material such as alumina.

The reproducing head portion 100A has, for example, a stacked structure in which a lower read shield layer 3 whose periphery is buried by an insulating film 4, a shield gap film 5, and an upper read shield layer 7 whose periphery is buried by an insulating layer 8 are stacked in this order. In the shield gap film 5, an MR device 6 as a reproducing device is buried so that one end face is exposed in a recording-medium-facing surface (air bearing surface) 40 which faces a recording medium.

The lower and upper read shield layers 3 and 7 are provided to electrically isolate the MR device 6 from the periphery. The lower and upper read shield layers 3 and 7 extend rearward from the air bearing surface 40 and, for example, have a rectangular shape in plan view having a width W3 as shown in FIG. 3. Each of the lower and upper read shield layers 3 and 7 is made of, for example, a magnetic material such as a nickel iron alloy (NiFe (for example, Ni: 80% by weight and Fe: 20% by weight) which will be simply called “permalloy (trademark)” hereinbelow). Each of the layers has a thickness of about 1.0 μm to 2.0 μm. The insulating layers 4 and 8 are provided to electrically isolate the lower and upper read shield layers 3 and 7, respectively, from the periphery and are made of, for example, a non-magnetic insulating material such as alumina.

The shield gap film 5 is provided to electrically isolate the MR device 6 from the periphery and is made of, for example, a nonmagnetic insulating material such as alumina.

The MR device 6 executes a magnetic process (reproducing process) by using, for example, GMR (Giant Magneto-Resistive) effect or TMR (Tunneling Magneto-Resistive) effect.

The recording head portion 100B has a configuration in which, for example, a magnetic pole layer 20 whose periphery is buried by insulating layers 11 and 13, a gap layer 14 in which an opening (back gap 14BG) for magnetic coupling is formed, a thin film coil 16 buried by an insulating layer 17, and a write shield layer 30 are stacked in this order.

The magnetic pole layer 20 is provided to contain a magnetic flux generated by the thin film coil 16 and to emit the magnetic flux toward a recording medium, thereby executing a magnetic process (recording process). The magnetic pole layer 20 extends rearward from the air bearing surface 40, concretely, extends to the back gap 14BG formed in the gap layer 14. The magnetic pole layer 20 has a two-layer structure in which a main magnetic pole layer 12 functioning as a magnetic flux emitting part and an auxiliary magnetic pole layer 10 functioning as a magnetic flux containing part for assuring a magnetic volume (magnetic flux containing amount) are stacked. The insulating layers 11 and 13 are respectively provided to electrically isolate the auxiliary magnetic pole layer 10 and the main magnetic pole layer 12 from the periphery and are made of, for example, a nonmagnetic insulating material such as alumina.

The auxiliary magnetic pole layer 10 extends from a position receded from the air bearing surface 40 on the leading side of the main magnetic pole layer 12, concretely, extends to the back gap 14BG and is coupled to the main magnetic pole layer 12. “Coupling” denotes not simple physical contact but physical contact and a magnetically conductible state. The definition of “coupling” will be similarly applied below. The auxiliary magnetic pole layer 10 is made of, for example, a material similar to that of the main magnetic pole layer 12 and has, as shown in FIG. 3, a rectangular plane shape having a width W2 smaller than the width W3 (W2<W3). The “leading side” is when a traveling state of the recording medium traveling in the medium travel direction M shown in FIGS. 1 and 2 is regarded as a flow, an inflow side (the side opposite to in the medium travel direction M) and is a down side in the thickness direction (Z-axis direction). On the other side, the outflow side (side in the medium travel direction M) is called a “trailing side” and is the upper side in the thickness direction.

The main magnetic pole layer 12 extends rearward from the air bearing surface 40 on the trailing side of the auxiliary magnetic pole layer 10, concretely, extends to the back gap 14BG like the auxiliary magnetic pole layer 10 and is made of, for example, a magnetic material such as permalloy or iron cobalt base alloy. Examples of the “iron cobalt base alloy” are an iron cobalt alloy (FeCo) and an iron cobalt nickel alloy (FeCoNi). Preferably, the main magnetic pole layer 12 is made of a magnetic material having high saturated magnetic flux density such as the iron cobalt base alloy. The main magnetic pole layer 12 includes, for example, from the side close to the air bearing face 40, a front end portion 12A having uniform width W1 specifying the recording track width (for example, W1=about 0.15 μm) and a rear end portion 12B coupled to the rear side of the front end portion 12A and having width W2 larger than the width W1 of the front end portion 12A (W2>W1). For example, the width of the rear end portion 12B is uniform (width W2) in the rear portion and is gradually narrowed toward the front end portion 12A in the front portion. The position where the width of the main magnetic pole layer 12 increases from the front end portion 12A (width W1) to the rear end portion 12B (width W2) is a “flare point (FP)” as one of important factors for determining the recording characteristics of the thin film magnetic head.

The gap layer 14 is to provide a gap for magnetically separating the magnetic pole layer 20 and the write shield layer 30 from each other. The gap layer 14 is made of a non-magnetic insulating material such as alumina and has a thickness of about 0.2 μm or less.

The thin film coil 16 generates a magnetic flux for recording and is made of, for example, a high conductive material such as copper (Cu). The thin film coil 16 has, for example, as shown in FIG. 1, a winding structure (spiral structure) that is wound around the back gap 14BG as a center. In particular, the length (the dimension in the Y-axis direction) of each of the parts of turns constructing the thin film coil 16 is relatively narrow on the front side of the back gap 14BG and is relatively wide on the back side of the back gap 14BG. In FIG. 1, only part of the plurality of turns of the thin film coil 16 is shown.

The insulating layer 17 covers the thin film coil 16 so as to be electrically isolated from the periphery and is formed on the gap layer 14 so as not to close the back gap 14BG. The insulating layer 17 is made of, for example, a nonmagnetic insulating material such as a photoresist (photosensitive resin), spin on glass (SOG), or the like which displays fluidity when heated, and the portion of the edge of the insulating layer 17 has a rounded and inclined surface. The forefront end position of the insulating layer 17 is a “throat height zero position TP” as one of important factors determining the recording performance of the thin film magnetic head. A distance between the air bearing surface 40 and the throat height zero position TP is a “throat height TH”. FIGS. 1 and 3 show, for example, the case where the throat height zero position TP coincides with the flare point FP.

The write shield layer 30 is a magnetic shield layer which receives a spread component of a magnetic flux emitted from the magnetic pole layer 20 and prevents spread of the magnetic flux. The write shield layer 30 has not only the function of preventing spread of the magnetic flux but also the function of, when a magnetic flux is emitted from the magnetic pole layer 20 toward a recording medium, collecting the magnetic flux via the recording medium (used for a recording process) and re-supplying the magnetic flux to the magnetic pole layer 20, that is, circulating the magnetic flux between the thin film magnetic head and the recording medium. The write shield layer 30 extends rearward from the air bearing surface 40 on the trailing side of the magnetic pole layer 20, thereby being isolated from the magnetic pole layer 20 by the gap layer 14 on the side close to the air bearing surface 40 and being coupled to the magnetic pole layer 20 via the back gap 14BG on the side far from the air bearing surface 40. Specifically, the write shield layer 30 extends rearward from the air bearing surface 40 to at least the back gap 14GB, concretely, to a portion rearward of the back gap 14BG and has an end face (exposed face) 30M exposed on the air bearing surface 40.

In particular, the write shield layer 30 has a characteristic configuration that the thickness on the side close to the air bearing surface 40 and that on the side far from the air bearing surface are different from each other as shown in FIG. 1. Specifically, the write shield layer 30 has a thickness T1 (first thickness) on the side far from the air bearing surface 40 and a thickness T2 (second thickness) larger than the thickness T1 (T2>T1) on the side close to the air bearing surface 40 on which the write shield layer 30 projects on both of the trailing and leading sides. The structural characteristics of the write shield layer 30 will be described more briefly. As obviously understood from the contour of the write shield layer 30 indicated by the thick line in FIG. 1, the main part on the front side of the back gap 14BG of the write shield layer 30 has an almost T-shaped section which extends in the Y-axis direction (lateral direction) while maintaining almost uniform thickness T1 on the side far from the air bearing surface 40 and whose thickness increases in the Z-axis direction (vertical direction) to the thickness T2 on the side close to the air bearing surface 40.

The write shield layer 30 includes: a TH specifying layer 15 (first magnetic shied layer part) which extends from the air bearing surface 40 to a predetermined rearward position P1 (first position) between the air bearing surface 40 and the back gap 14BG; and a yoke layer 18 (second magnetic shield layer part) constructed as a member separate from the TH specifying layer 15 and extending rearward from the air bearing surface 40 to at least the back gap 14BG while partially lying on the TH specifying layer 15. That is, the write shield layer 30 has a stacked structure in which the TH specifying layer 15 and the yoke layer 18 are stacked in this order.

The TH specifying layer 15 functions as a main magnetic flux receiving port and has a thickness T3 (third thickness) as shown in FIG. 1. The TH specifying layer 15 is made of a magnetic material such as permalloy, iron nickel alloy (FeNi), or iron cobalt base alloy and has a rectangular shape having a width W3 in plan view as shown in FIG. 3. To the TH specifying layer 15, the insulating layer 17 in which the thin film coil 16 is buried is adjacent. That is, the TH specifying layer 15 plays the role of specifying the forefront end position of the insulating layer 17 (throat height zero position TP).

The yoke layer 18 functions as a path of the magnetic flux received from the TH specifying layer 15. The yoke layer 18 extends, for example, from the air bearing surface 40 to a position rearward of the back gap 14BG so that it extends partially on the TH specifying layer 15 on the front side of the back gap 14BG and is partially coupled to the magnetic pole layer 20 via the back gap 14BG. In particular, for example, as shown in FIG. 1, the yoke layer 18 has the thickness T1 on the side far from the air bearing surface 40 and a thickness T4 (fourth thickness) larger than the thickness T1 (T4>T1) by projecting only to the trailing side on the side close to the air bearing surface 40. The yoke layer 18 is made of a magnetic material similar to that of the TH specifying layer 15 and has a rectangular shape having a width W3 in plan view as shown in FIG. 3. The thickness T2 of the write shield layer 30 is specified as the sum of the thickness T3 of the TH specifying layer 15 and the thickness T4 of the front portion of the yoke layer 18 (T2=T3+T4).

In particular, the yoke layer 18 has, for example, a configuration obtained by coupling two parts as separate members. Concretely, the yoke layer 18 includes a yoke layer part 18A (second main magnetic shield layer part) extending rearward from the air bearing surface 40 to at least the back gap 14BG while partially lying on the TH specifying layer 15, concretely, extending from the air bearing surface 40 to a position rearward of the back gap 14BG and having the thickness T1, and a yoke layer part 18B (second sub magnetic shield layer part) extending from the air bearing surface 40 to a position P2 (second position) between the air bearing surface 40 and the back gap 14BG while partially lying on the yoke layer part 18A on the trailing side of the yoke layer part 18A and having a thickness T5 (fifth thickness). That is, the yoke layer 18 has a stacked structure in which the yoke layer parts 18A and 18B are stacked in this order. It is preferable that the yoke layer part 18A be made of, for example, a material having high resistivity, concretely, a material having resistivity RA higher than resistivity RB of the yoke layer part 18B (RA>RB). On the other hand, it is preferable that the yoke layer part 18B be made of, for example, a material having high saturated magnetic flux density, concretely, a material having saturated magnetic flux density SB higher than saturated magnetic flux density SA of the yoke layer part 18A (SB>SA). In the embodiment, the yoke layer part 18A is made of an iron nickel alloy (FeNi having resistivity RA=about 45 μΩcm and saturated magnetic flux density SA=about 1.5 T to 1.6 T), and the yoke layer part 18B is made of an iron cobalt nickel alloy (FeCoNi having resistivity RB=about 18 μΩcm and saturated magnetic flux density SB=about 1.8 T to 2.0 T). The thickness T4 of the yoke layer 18 is specified by the sum of the thickness T1 of the yoke layer part 18A and the thickness T5 of the yoke layer part 18B (T4=T1+T5). The positional relation between the yoke layer part 18B and the TH specifying layer 15 is as follows. For example, the position P2 as the extension end of the yoke layer part 18B is rearward of the position P1 as the extension end of the TH specifying part 15. That is, the yoke layer part 18B extends rearward of the TH specifying part 15. Each of the yoke layer parts 18A and 18B has, for example, a rectangular shape in plan view as shown in FIG. 3.

The operation of the thin film magnetic head will now be described with reference to FIGS. 1 to 3.

In the thin film magnetic head, at the time of recording information, when a current flows into the thin film coil 16 of the recording head portion 100B via a not-shown external circuit, a magnetic flux is generated in the thin film coil 16. The magnetic flux generated at this time is contained by the auxiliary magnetic pole layer 10 and the main magnetic pole layer 12 constructing the magnetic pole layer 20 and, after that, flows from the rear end portion 12B to the front end portion 12A in the main magnetic pole layer 12. Since the magnetic flux flowing in the magnetic pole layer 20 is converged at the flare point FP as the width of the magnetic pole layer 20 decreases, the magnetic flux is concentrated in the trailing side portion of the front end portion 12A. When the magnetic flux concentrated in the trailing side portion is emitted from the front end portion 12A to the outside, a recording magnetic field (perpendicular magnetic field) is generated in the direction orthogonal to the surface of a recording medium and the recording medium is magnetized in the perpendicular direction by the perpendicular magnetic field, thereby magnetically recording information onto the recording medium. At the time of recording information, a spread component of the magnetic flux emitted from the front end portion 12A is received by the write shield layer 30, so that the magnetic flux is prevented from spreading. Since the magnetic flux emitted from the front end portion 12A and passed through a recording medium (used for the recording process) is collected by the write shield layer 30, the magnetic flux is circulated between the thin film magnetic head and the recording medium.

At the time of reproduction, when a sense current flows into the MR device 6 in the reproducing head portion 100A, the resistance value of the MR device 6 changes according to a signal magnetic field from the recording medium. By detecting the resistance change of the MR device 6 as a change in the sense current, the information recorded on the recording medium is magnetically read out.

In the thin film magnetic head according to the embodiment, the write shield layer 30 has the thickness T1 on the side far from the air bearing surface 40 and has the thickness T2 larger than the thickness T1 (T2>T1) by making the write shield layer 30 project on both the trailing and leading sides on the side close to the air bearing surface 40, so that stability of the recording process can be assured for the following reason.

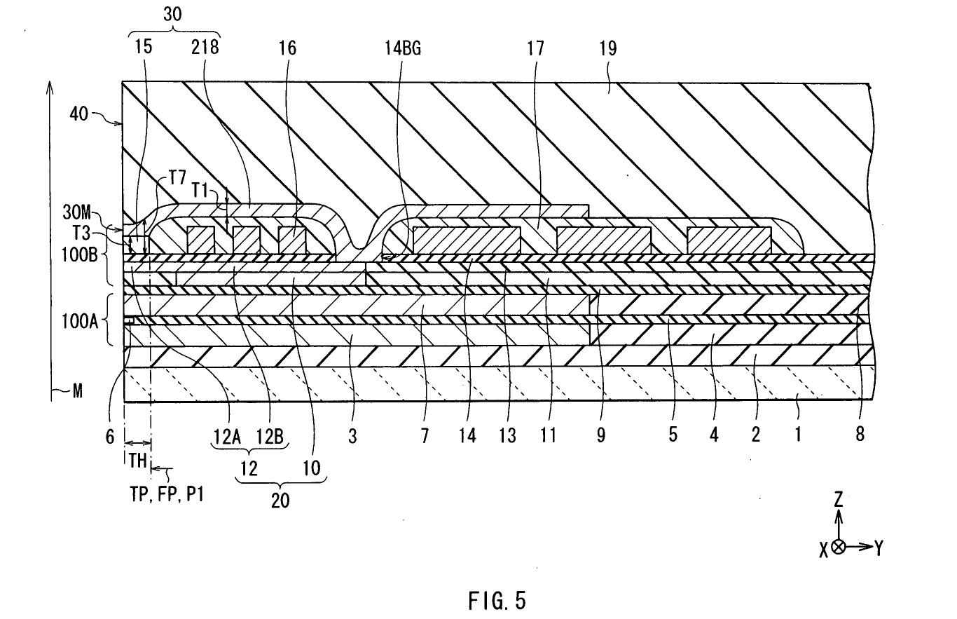

FIG. 4 shows the configuration of a thin film magnetic head as a first comparative example of the thin film magnetic head according to the embodiment, and FIG. 5 shows the configuration of a thin film magnetic head as a second comparative example of the thin film magnetic head according to the embodiment. Both of FIGS. 4 and 5 are cross sections corresponding to FIG. 1. In the thin film magnetic head of the first comparative example, the write shield layer 30 includes a yoke layer 118 having a uniform thickness T4 as a whole in place of the yoke layer 18. That is, the thin film magnetic head of the first comparative has a configuration similar to that of the thin film magnetic head of the embodiment except for the point that the write shield layer 30 has the thickness T4 on the side far from the air bearing surface 40 and projects only to the leading side on the side close to the air bearing surface 40, and the projected portion has a thickness T6 larger than the thickness T4 (T6>T4, T6=T3+T4). In the thin film magnetic head of the second comparative example, the write shield layer 30 includes a yoke layer 218 having a uniform thickness T1 as a whole in place of the yoke layer 18. That is, the thin film magnetic head of the second comparative has a configuration similar to that of the thin film magnetic head of the embodiment except for the point that the write shield layer 30 has the thickness T1 on the side far from the air bearing surface 40 and projects only to the leading side on the side close to the air bearing surface 40, and the projected portion has a thickness T7 larger than the thickness T1 (T7>T1, T7=T1+T3).

In the thin film magnetic head of the first comparative example (refer to FIG. 4), since the yoke layer 118 has the relatively large thickness T4 as a whole, the volume of the whole write shield layer 30 becomes relatively large. In this case, the area of the exposed face 30M becomes sufficiently large in the front part of the write shield layer 30, and the magnetic volume in the portion around the air bearing surface 40 becomes sufficiently large. Consequently, the magnetic flux received from the exposed face 30M of the write shield layer 30 becomes less concentrated in the portion around the air bearing surface 40, so that occurrence of unintended overwriting of information is suppressed. The “unintended overwriting of information” is a trouble such that an unnecessary magnetic field is generated due to concentration of the magnetic flux in the portion around the air bearing surface 40 in the write shield layer 30 and information recorded on a recording medium is overwritten with the unnecessary recording magnetic field. However, in the thin film magnetic head of the first comparative example, although occurrence of unintended overwriting of information is suppressed, an amount of thermal expansion becomes too large in the rear part of the write shield layer 30 due to the fact that the volume of the whole white shield layer 30 is too large. In this case, when the environment temperature increases due to heat generated in the recording operation of the thin film magnetic head, by the influence of the heat, the write shield layer 30 tends to be excessively expanded and a projection defect tends to occur. The “projection defect” is a trouble that a component (for example, the write shield layer 30) of the thin film magnetic head unintentionally projects from the air bearing surface 40 (free end) due to thermal expansion, and is a serious defect which can make the thin film magnetic head collide with the recording medium. Consequently, in the thin film magnetic head of the first comparative example, occurrence of unintended overwriting of information can be suppressed but occurrence of a projection defect cannot be suppressed. It is therefore difficult to stabilize the recording process from both of the viewpoint of suppression of occurrence of unintended overwriting of information and the viewpoint of suppression of occurrence of a projection defect.

On the other hand, in the thin film magnetic head of the second comparative example (refer to FIG. 5), the yoke layer 218 has the relatively small thickness T1 as a whole, so that the volume of the whole write shield layer 30 becomes relatively small. In this case, in the rear portion of the write shield layer 30, the thermal expansion amount becomes sufficiently small. Consequently, even if the environment temperature rises in the recording operation of the thin film magnetic head, excessive expansion of the write shield layer 30 due to the influence of the heat is suppressed, so that occurrence of a projection defect is suppressed. However, in the thin film magnetic head of the second comparative example, although occurrence of the projection defect is suppressed, because the volume of the whole write shield layer 30 is too small, the area of the exposed face 30M becomes excessively small in the front portion of the write shield layer 30 and the magnetic volume in the portion around the air bearing surface 40 becomes excessively small. In this case, the magnetic flux received from the exposed face 30M of the write shield layer 30 tends to be concentrated in the portion around the air bearing surface 40, and unintended overwriting of information tends to occur. Consequently, in the thin film magnetic head of the second comparative example, although occurrence of a projection defect can be suppressed, occurrence of unintended overwriting of information cannot be suppressed. It is therefore still difficult to stabilize the recording process from the viewpoint of both of suppression of occurrence of unintended overwriting of information and suppression of occurrence of a projection defect.

In contrast, in the thin film magnetic head of the embodiment (refer to FIG. 1), the yoke layer 18 has the relatively small thickness T1 in the rear portion and has the relatively large thickness T4 in the front portion, so that the volume of the write shield layer 30 is relatively small in the rear portion and is relatively large in the front portion. In this case, the area of the exposed face 30M is sufficiently large and the magnetic volume around the air bearing surface 40 is sufficiently large in the front portion of the write shield layer 30, and the thermal expansion amount becomes sufficiently small in the rear portion. Consequently, the magnetic flux received from the exposed face 30M of the write shield layer 30 becomes less concentrated in the portion around the air bearing face 40, so that occurrence of unintended overwriting of information is suppressed. In addition, excessive expansion of the write shield layer 30 due to the influence of heat is suppressed, so that occurrence of a projection defect is suppressed. Therefore, in the thin film magnetic head according to the embodiment, occurrence of unintended overwriting of information can be suppressed and occurrence of a projection defect can be also suppressed. As a result, the recording process is stabilized from the viewpoint of both of suppression of occurrence of unintended overwriting of information and suppression of occurrence of a projection defect. Thus, the stability of the recording process can be assured.

In particular, in the embodiment, the position P2 of the extension end of the yoke layer part 18B in the write shield layer 30 is rearward of the position P1 of the extension end of the TH specifying layer 15, that is, the yoke layer part 18B extends to a position rearward of the TH specifying layer 15, so that the volume of the yoke layer part 18B becomes sufficiently larger than that of the TH specifying layer 15. Therefore, the magnetic volume of the yoke layer part 18B becomes sufficiently large, so that occurrence of unintended overwriting of information can be efficiently suppressed.

In the embodiment, the yoke layer parts 18A and 18B of the yoke layer 18 are constructed as members separate from each other, the yoke layer part 18A is made of a material having the resistivity RA higher than the resistivity RB of the yoke layer part 18B (RA>RB), and the yoke layer part 18B is made of a material having the saturated magnetic flux density SB higher than the saturated magnetic flux density SA of the yoke layer part 18A (SB>SA). Consequently, a high frequency characteristic can be assured on the basis of the high resistivity characteristic of the yoke layer part 18A and occurrence of magnetic saturation can be prevented on the basis of the high saturated magnetic flux density characteristic of the yoke layer part 18B.

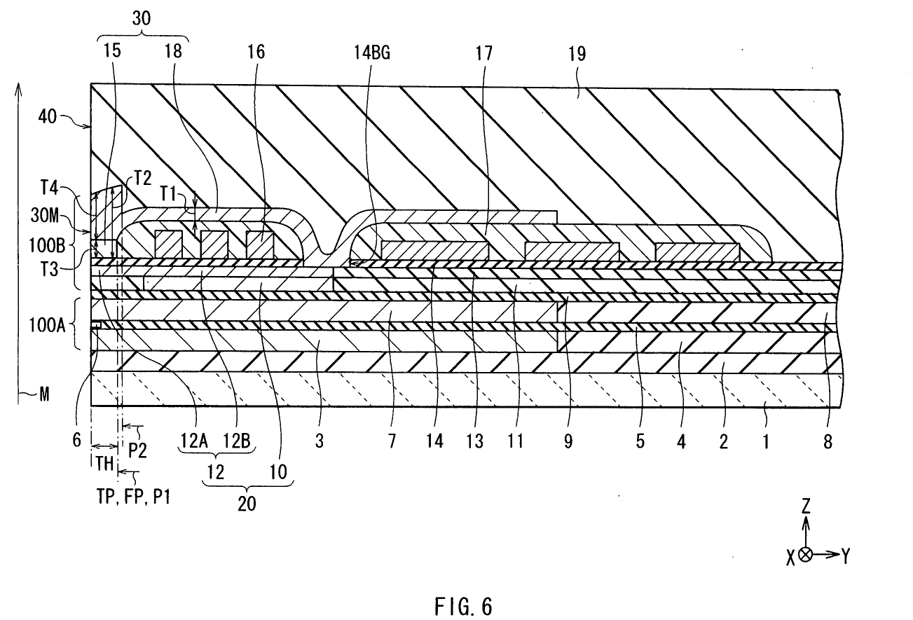

In the embodiment, as shown in FIG. 1, the yoke layer parts 18A and 18B of the yoke layer 18 are constructed as members separate from each other. The invention is not always limited to the embodiment. For example, as shown in FIG. 6, the yoke layer parts 18A and 18B may be constructed integrally. Obviously, also in the thin film magnetic head shown in FIG. 6, the relations among the thicknesses T1 to T4 are similar to those of the foregoing embodiment. In this case as well, effects similar to those of the foregoing embodiment can be obtained. The other configuration of the thin film magnetic head shown in FIG. 6 are similar to those of the case shown in FIG. 1.

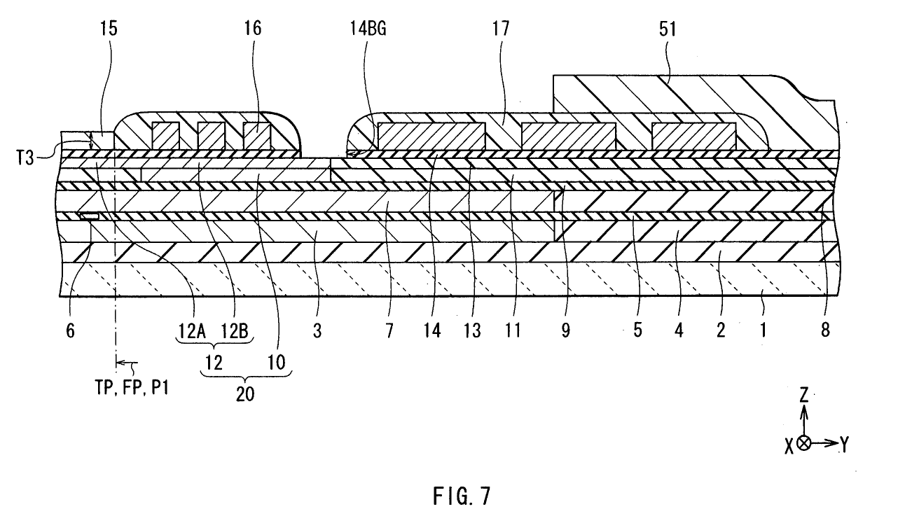

A method of manufacturing the thin film magnetic head of the embodiment will now be described with reference to FIGS. 1 to 3 and FIGS. 7 to 10. FIGS. 7 to 10 are diagrams for explaining processes of manufacturing the thin film magnetic head and show sectional configurations corresponding to FIG. 1.

In the following, first, an outline of processes of manufacturing a whole thin film magnetic head will be described with reference to FIG. 1. After that, processes of forming a main portion (the write shield layer 30) of the thin film magnetic head will be described in detail with reference to FIGS. 1 to 3 and FIGS. 7 to 10. Since the materials, dimensions, structural features, and the like of the series of the components of the thin film magnetic head have been already described in detail, the description will not be repeated.

The thin film magnetic head is manufactured by sequentially forming and stacking the components by mainly using an existing thin film process including a film forming technique such as plating and sputtering, a patterning technique such as photolithography technique, and an etching technique such as dry etching and wet etching. Specifically, first, as shown in FIG. 1, the insulating layer 2 is formed on the substrate 1 and, after that, the lower read shield layer 3 whose periphery is buried by the insulating layer 4, the shield gap film 5 in which the MR device 6 is buried, and the upper read shield layer 7 whose periphery is buried by the insulating layer 8 are stacked on the insulating layer 2 in accordance with this order, thereby forming the reproducing head portion 100A. Subsequently, the isolation layer 9 is formed on the reproducing head portion 100A. On the isolation layer 9, by sequentially stacking the magnetic pole layer 20 (auxiliary magnetic pole layer 10 and the main magnetic pole layer 12) whose periphery is buried by the insulating layers 11 and 13, the gap layer 14 in which the back gap 14BG is formed, the insulating layer 17 in which the thin film coil 16 is buried, and the write shield layer 30 (the TH specifying layer 15 and the yoke layer 18), the recording head portion 100B is formed. Finally, the overcoat layer 19 is formed on the recording head portion 100B and, after that, the air bearing surface 40 is formed by using mechanism processing and polishing process, thereby completing the thin film magnetic head.

At the time of forming the write shield layer 30 as a main part of the thin film magnetic head, the gap layer 14 including the back gap 14BG is formed. First, as shown in FIG. 7, by making a plating film selectively grow in the area forward of the flare point FP on the gap layer 14, the TH specifying layer 15 as part of the write shield layer 30 is pattern-formed. The TH specifying layer 15 is formed so as to extend from a position in which the air bearing surface 40 (refer to FIG. 1) is to be formed in a post process to the position P1 between the air bearing surface 40 and the back gap 14BG while being adjacent to the gap layer 14 and so as to have the thickness T3. In this case, particularly, as described above, considering that the throat height zero position TP (refer to FIG. 1) is finally specified on the basis of the formation position of the TH specifying layer 15, the position P1 of the extension end of the TH specifying layer 15 is set. To form the TH specifying layer 15 by using the plating growing process, for example, a not-shown frame (photoresist pattern) for forming a pattern film is used. The process of forming the photoresist pattern will be described later.

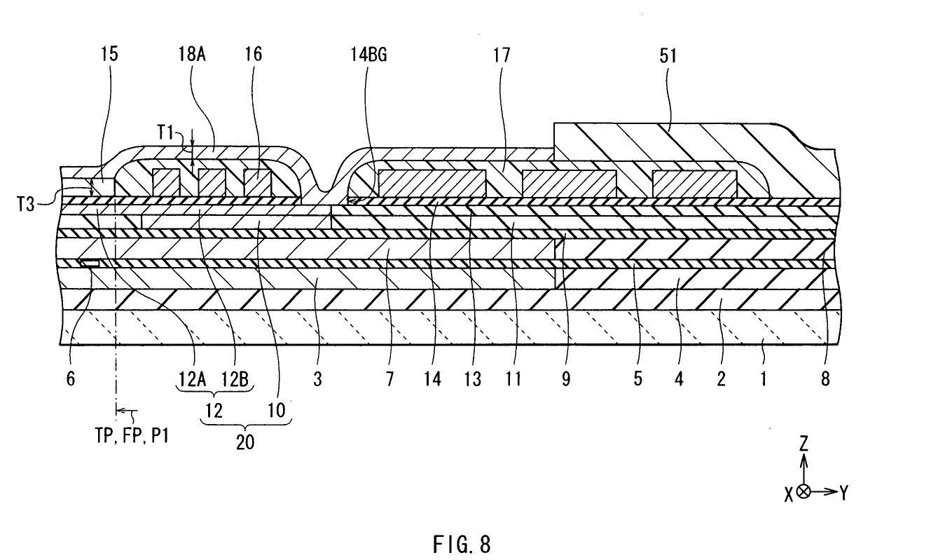

Subsequently, as shown in FIG. 7, the thin film coil 16 is formed on the gap layer 14 and the insulating layer 17 is formed so as to cover the spaces among turns of the thin film coil 16 and the gap layer 14 in the periphery of the thin film coil 16 and so as not to bury the back gap 14BG. On the basis of the forefront end position of the insulating layer 17, the throat height zero position TP is specified. After that, a photoresist pattern 51 is formed so as to cover the insulating layer 17 and the gap layer 14 in the periphery of the insulating layer 17. At the time of forming the photoresist pattern 51, for example, a photoresist film is formed by applying a photoresist on the surface of the gap layer 14, TH specifying layer 15, insulating layer 17, and its peripheral area and is patterned (with exposure and development) by using a photolithography process, thereby forming an opening in which the yoke layer part 18A (refer to FIG. 8) will be formed in a post process, that is, covering the area except for the area in which the yoke layer part 18A is to be formed. In this case, for example, the photoresist pattern 51 is disposed so that the front end of the photoresist pattern 51 is positioned rearward of the back gap 14BG, that is, the insulating layer 17 is partially covered on the rear side of the back gap 14BG.

Subsequently, by making a plating film selectively grow by using the photoresist pattern 51, as shown in FIG. 8, the yoke layer part 18A as part of the yoke layer 18 is formed in the opening of the photoresist pattern 51. The yoke layer part 18A is formed so as to be partially on the TH specifying layer 15 and extend from a position in which the air bearing surface 40 is to be formed in a post process to at least the back gap 14BG as a rearward position, concretely, to a position rearward of the back gap 14BG while having the thickness T1 as a whole.

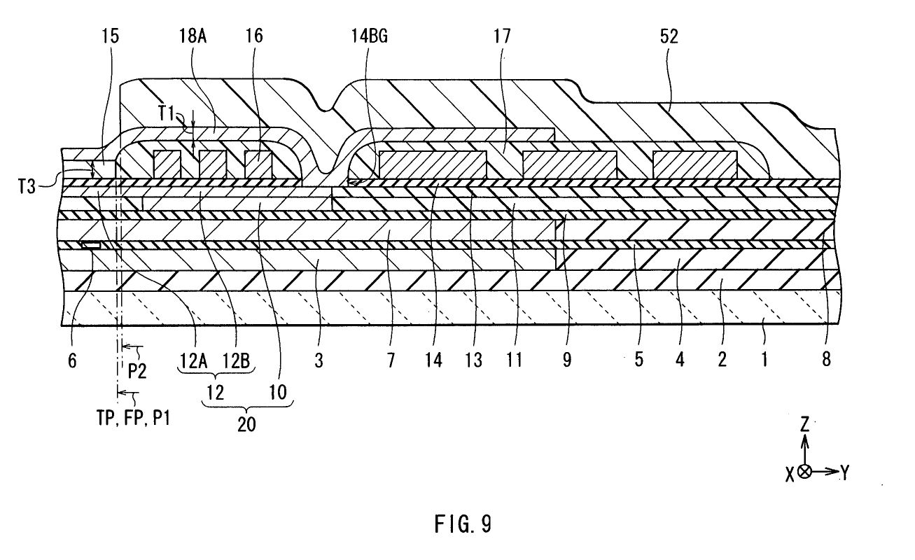

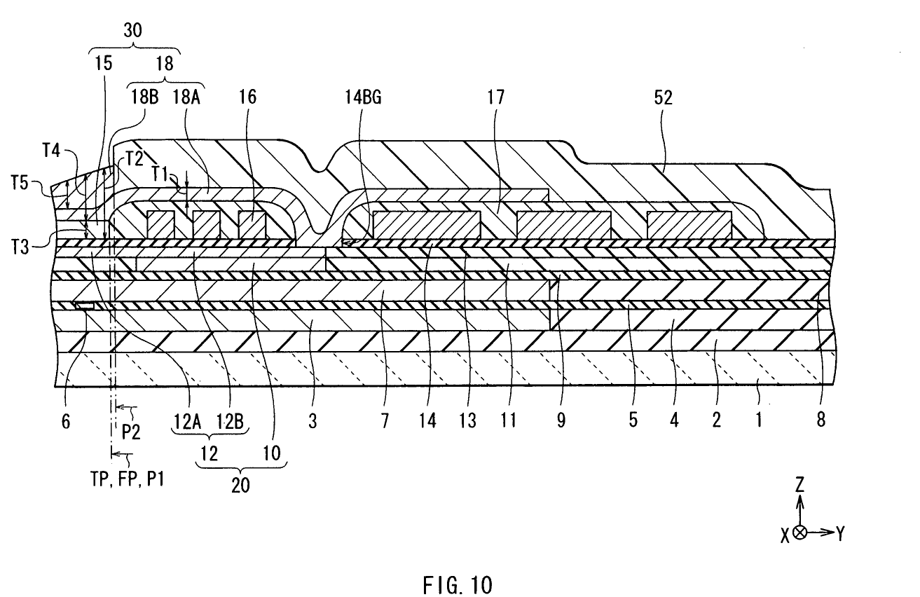

Subsequently, the used photoresist pattern 51 is removed and, after that, as shown in FIG. 9, a photoresist pattern 52 is formed so as to cover the gap layer 14, insulating layer 17, and yoke layer part 18A. The photoresist pattern 52 is formed so that an opening is provided in an area in which the yoke layer part 18B (refer to FIG. 10) is to be formed in a post process, that is, so as to cover the area other than the area in which the yoke layer part 18B is to be formed. In this case, for example, the photoresist pattern 52 is provided so that the front end of the photoresist pattern 52 is in the position P2 rearward of the position P1, that is, so as to partially cover the yoke layer part 18A on the rear side of the TH specifying layer 15.

After that, a plating film is selectively grown by using the photoresist pattern 52, thereby forming the yoke layer part 18B as another part of the yoke layer 18 in the opening of the photoresist pattern 52 as a member separate from the yoke layer part 18A as shown in FIG. 10. The yoke layer part 18B is formed so as to be partially on the yoke layer part 18A on the trailing side of the yoke layer part 18A and extend from a position in which the air bearing surface 40 is to be formed in a post process to the rearward position P2 between the air bearing surface 40 and the back gap 14BG while having the thickness T5. Consequently, the yoke layer 18 is formed so as to include the yoke layer parts 18A and 18B and to have the thickness T4 as the sum of the thickness T1 of the yoke layer part 18A and the thickness T5 of the yoke layer part 18B (T4=T1+T5). Specifically, the yoke layer 18 is formed so as to have the thickness T1 on the side far from the position in which the air bearing surface 40 is to be formed in a post process and to have the thickness T4 larger than the thickness T1 (T4>T1) by projecting only to the trailing side on the side close to the position in which the air bearing surface 40 is to be formed. As a result, the write shield layer 30 is formed and becomes complete, which includes the TH specifying layer 15 and the yoke layer 18. has the thickness T1 on the side far from the air bearing surface 40, and has the thickness T2 larger than the thickness T1 (T2>T1) by projecting both to the trailing and leading sides on the side close to the air bearing surface 40.

In the above, to simplify the explanation, the write shield layer 30 (the TH specifying layer 15 and the yoke layer 18 (the yoke layer parts 18A and 18B) becomes complete at the time point shown in FIG. 10. To be strict, the used photoresist pattern 52 is removed, an end face of the structure of the stacked layers from the substrate 1 to the write shield layer 30 is polished by using, for example, the lapping technique, and the air bearing surface 40 including the exposed face 30M of the write shield layer 30 is formed as the polished planarized face, thereby substantially completing the write shield layer 30.

In the method of manufacturing the thin film magnetic head according to the embodiment, to form the write shield layer 30 having the thickness T1 on the side far from the air bearing surface 40 and the thickness T2 larger than the thickness T1 (T2>T1) by projecting to both the trailing and leading sides on the side close to the air bearing surface 40, only the existing thin film processes including the film forming technique, patterning technique and etching technique are used and a novel and complicated manufacturing process is not used. Therefore, in the embodiment, the thin film magnetic head realizing assured stability in the recording process can be manufactured easily by using only the existing thin film processes.

In particular, in the embodiment, the yoke layer 18 in the write shield layer 30 is formed by separate members. Concretely, the yoke layer part 18A having the thickness T1 and the yoke layer part 18B having the thickness T5 are formed as separate members and used as part of the write shield layer 30. Consequently, the thickness T1 is specified in the process of forming the yoke layer part 18A and the thickness T5 is specified in the process of forming the yoke layer part 18B. That is, the thicknesses T1 and T5 are specified independently of each other in the different processes. Therefore, the thicknesses T1 and T5 are strictly controlled in the different processes, so that the thickness T4 specified by the sum of the thicknesses T1 and T5 (T4=T1+T5) can be controlled strictly.

In this case, further, by forming the yoke layer parts 18A and 18B as members separate from each other, the yoke layer parts 18A and 18B can be formed of materials different from each other. Thus, the material of each of the yoke layer parts 18A and 18B can be freely set in consideration of the performances and the like of the thin film magnetic head.

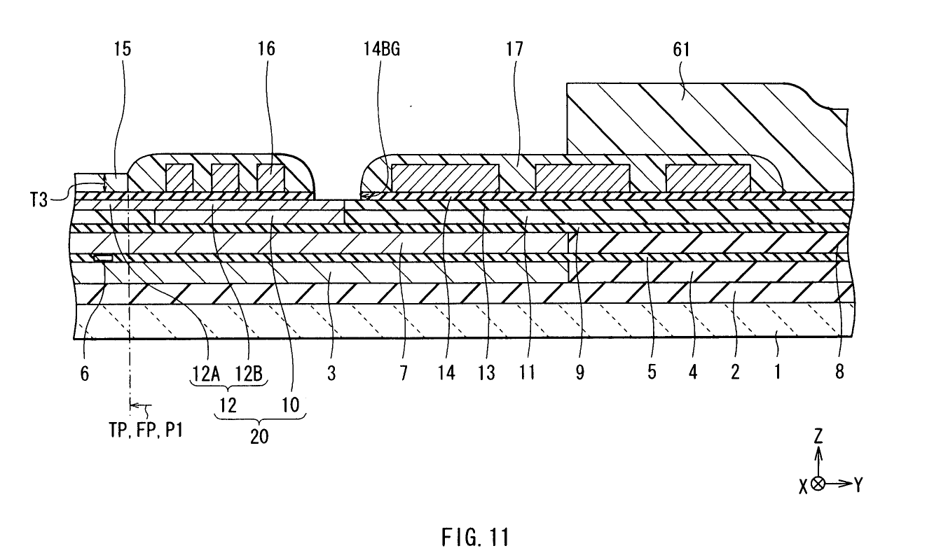

In the embodiment, as shown in FIGS. 7 to 10, the yoke layer 18 in the write shield layer 30 is formed by separate members. The invention, however, is not limited to the embodiment. For example, as a modification of the configuration of the thin film magnetic head, as shown in FIG. 6, the yoke layer 18 may be formed integrally, specifically, by forming the yoke layer parts 18A and 18B integrally. The integrated yoke layer 18 can be formed by the process of manufacturing the thin film magnetic head shown in FIGS. 11 to 14.

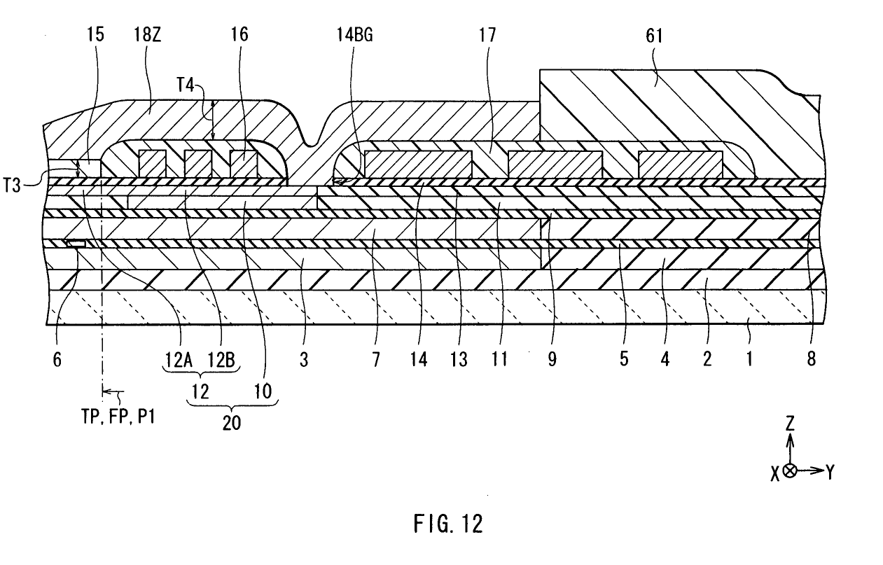

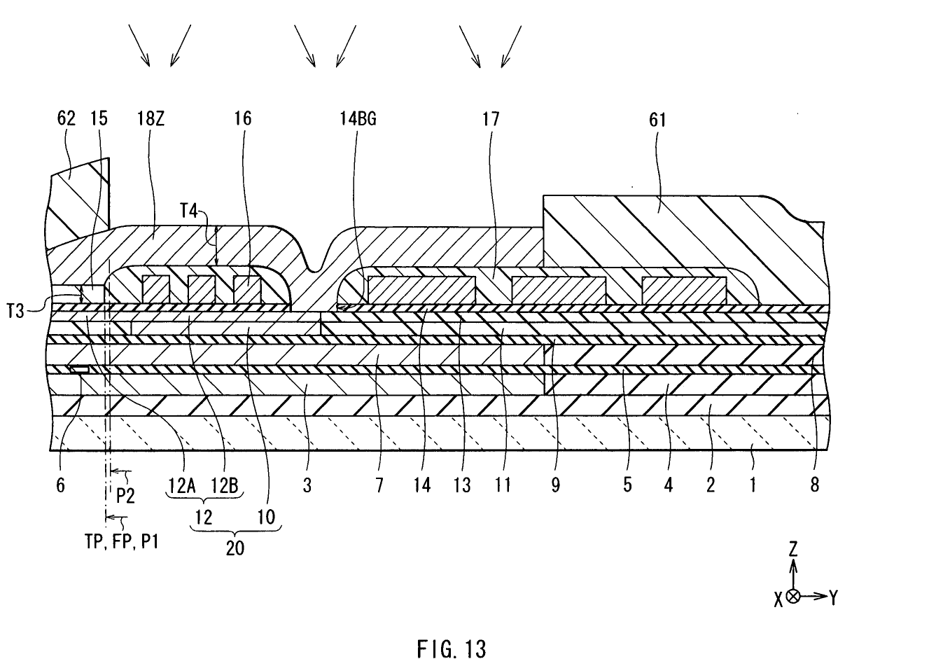

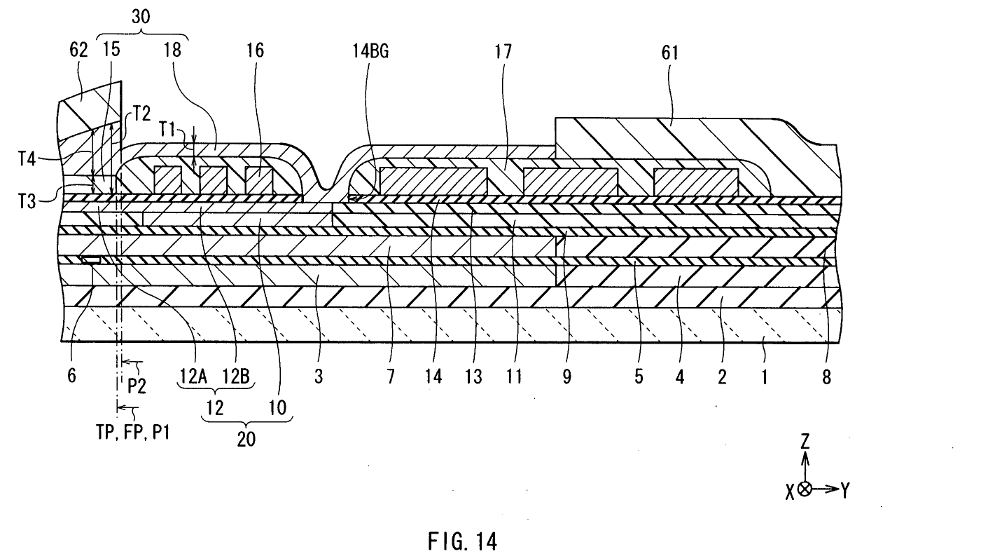

At the time of forming the integrated yoke layer 18, the TH specifying layer 15 is formed by a process similar to that described with reference to FIG. 7. After that, as shown in FIG. 11, by using a procedure similar to that of the case where the photoresist pattern 51 is formed in the foregoing embodiment, a photoresist pattern 61 is formed so as to have an opening in an area where a pre-yoke layer 18Z (refer to FIG. 12) is to be formed in a post process. Subsequently, by making a plating film selectively grown in the opening in the photoresist pattern 61, as shown in FIG. 12, the pre-yoke layer 18Z as a preparation layer of the yoke layer 18 is formed. The pre-yoke layer 18Z is formed so as to extend rearward from the position in which the air bearing surface 40 is to be formed in a post process to at least the back gap 14BG while partially lying on the TH specifying layer 15 and having the thickness T4 as a whole. Concretely, the pre-yoke layer 18Z is formed so as to extend to a position rearward of the back gap 14BG while covering the insulating layer 17. That is, the configuration of the pre-yoke layer 18Z corresponds to the configuration described in the foregoing embodiment except that the thickness of the yoke layer part 18A is changed from T1 to T4. Subsequently, while making the photoresist pattern 61 remained, as shown in FIG. 13, a photoresist pattern 62 is formed so as to have an opening in a manner similar to the photoresist pattern 61, in an area where the write shield layer 30 has the thickness T1 in the foregoing embodiment, that is, the area real-ward of the position P2. After that, the photoresist patterns 61 and 62 are used as a mask and a part on the side far from the position in which the air bearing surface 40 is to be formed in a post process in the pre-yoke layer 18Z is selectively etched to have the thickness T1 by using, for example, ion milling, thereby forming the yoke layer 18 having the thickness T1 on the side far from the position in which the air bearing surface 40 is to be formed in a post process and having the thickness T4 on the side close to the air bearing surface 40 as shown in FIG. 14. It completes the integral yoke layer 18. Obviously, in this case as well, strictly, yoke layer 18 becomes substantially complete by removing the used photoresist patterns 61 and 62 and forming the air bearing surface 40 by using the lapping technique or the like. The etching method for etching the pre-yoke layer 18Z is not always limited to ion milling but an etching method other than ion milling may be used. Except for the above, the procedure for manufacturing the thin film magnetic head shown in FIGS. 11 to 14 is similar to that of the thin film magnetic head shown in FIGS. 7 to 10.

The thin film magnetic head according to the embodiment of the invention and its manufacturing method have been described above.

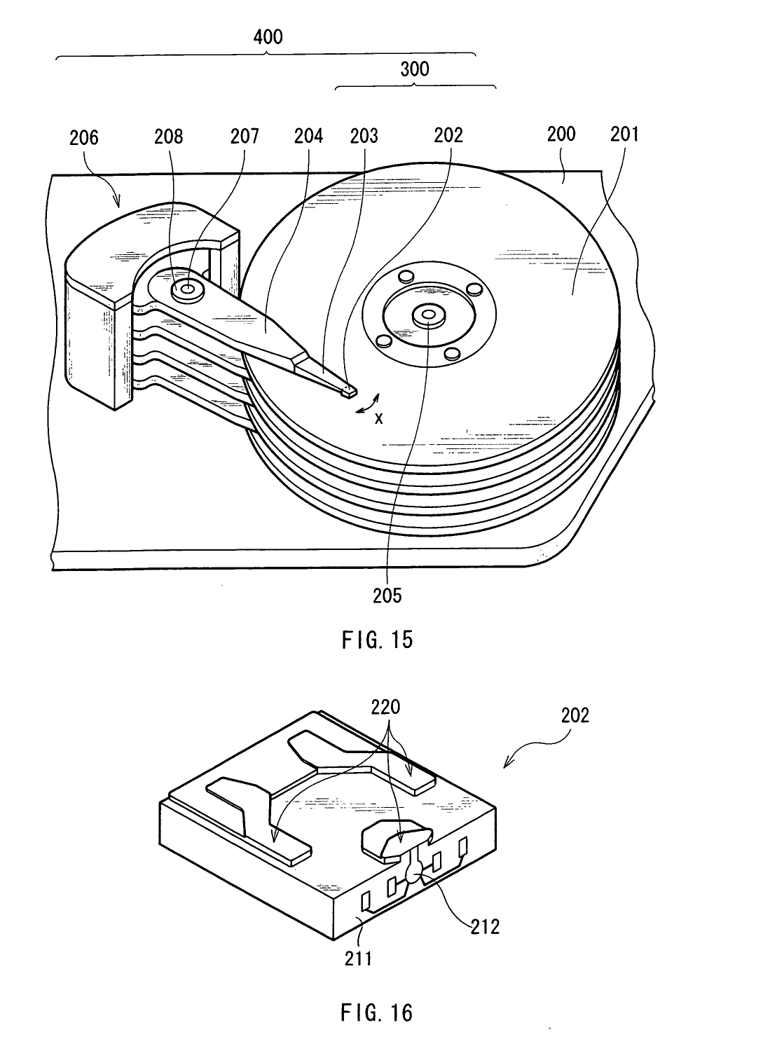

Next, with reference to FIGS. 15 and 16, the configuration of a magnetic recording apparatus on which the thin film magnetic head of the invention is mounted will be described. FIGS. 15 and 16 show a configuration of the magnetic recording apparatus. FIG. 15 is a perspective view showing a general configuration, and FIG. 16 is an enlarged perspective view showing the configuration of a main part. Since each of the “head gimbals assembly” and “head arm assembly” of the invention is part of the magnetic recording apparatus, the head gimbals assembly and the head arm assembly will be also described hereinbelow.

The magnetic recording apparatus shown in FIGS. 15 and 16 is an apparatus on which the thin film magnetic head of the embodiment is mounted and is, for example, a hard disk drive. The magnetic recording apparatus has, as shown in FIG. 15, for example in a casing 200, a plurality of magnetic disks (for example, hard disks) 201 as recording media on which information is magnetically recorded, a plurality of suspensions 203 disposed in correspondence with the magnetic disks 201 in a one-to-one corresponding manner and each supporting a magnetic head slider 202 at one end, and a plurality of arms 204 each supporting the other end of the suspension 203. The magnetic disk 201 is rotatable around a spindle motor 205 fixed to the casing 200 as a center. The arms 204 are connected to a driving unit 206 as a power source and are swingable via a bearing 208 around a fixed shaft 207 fixed to the casing 200 as a center. The driving unit 206 includes a driving source such as a voice coil motor. This magnetic recording apparatus is of a model in which the plurality of arms 204 can swing integrally around the fixed shaft 207 as a center. In FIG. 15, the casing 200 is partially cut away so that the inner structure of the magnetic recording apparatus can be seen easily.

The magnetic head slider 202 has a configuration such that, as shown in FIG. 16, a thin film magnetic head 212 executing both of a recording process and a reproducing process is attached to a face of a substrate 211 made of a nonmagnetic insulating material such as altic and having an almost rectangular parallelepiped shape. The substrate 211 has, for example, a face (air bearing surface 220) including projections and depressions to decrease air resistance which occurs when the arm 204 swings. The thin film magnetic head 212 is provided in another face (face on the right front side in FIG. 16) orthogonal to the air bearing surface 220. The thin film magnetic head 212 has the configuration described in the foregoing embodiment. When the magnetic disk 201 rotates at the time of recording or reproducing information, the head slider 202 floats from the recording surface of the magnetic disk 201 by using the air flow generated between the recording surface (surface facing the head slider 202) and the air bearing surface 220. FIG. 16 shows the upside down state of FIG. 15 so that the structure on the air bearing surface 220 side of the magnetic head slider 202 can be seen well.

The assembly structure having the magnetic head slider 202 to which the thin film magnetic head 212 is attached and the suspension 203 supporting the magnetic head slider 202 at its one end is a so-called head gimbals assembly (HGA) 300. The assembly structure having the arm 204 supporting the other end of the suspension 203 and the driving unit 206 together with the above mentioned magnetic head slider 202 and the suspension 203 is a so-called head arm assembly (HAA) 400.

In the magnetic recording apparatus, at the time of recording or reproducing information, by swing of the arm 204, the magnetic head slider 202 moves to a predetermined area (recording area) in the magnetic disk 201. When current is passed to the thin film magnetic head 212 in a state where it faces the magnetic disk 201, by the operation described in the foregoing embodiment, the thin film magnetic head 212 performs the recording process or reproducing process on the magnetic disk 201.

Since the magnetic recording apparatus has the thin film magnetic head 212 of the invention, the recording process is stabilized from the viewpoints of both of suppression of occurrence of unintended overwriting of information and suppression of occurrence of a projection defect. Thus, stability of the recording process can be assured.

The other configuration, operation, action, effect, and modification of the thin film magnetic head 212 mounted on the magnetic recording apparatus are similar to those of the foregoing embodiment, so that their description will not be repeated.

### EXAMPLE

An example of the invention will now be described.

The characteristics of the thin film magnetic head described in the foregoing embodiment (hereinbelow, simply called “thin film magnetic head of the invention”) were examined and the following series of results were obtained.

First, the occurrence situation of unintended overwriting of information was examined and the result shown in Table 1 was obtained. Table 1 shows the correlation between the configuration of the yoke layer 18 in the write shield layer 30 and the magnetic field intensity. The occurrence situation of unintended overwriting of information was examined by modeling fluctuations in the magnetic field intensity at the leading edge of the write shield layer 30 by changing the thickness T4 on the side close to the air bearing surface 40 of the yoke layer 18 in three levels of 3.0 μm, 2.0 μm, and 1.0 μm while fixing the thickness T1 on the side far from the air bearing surface 40 of the yoke layer 18 in the write shield layer 30 to 1.0 μm. Table 1 shows, as the magnetic field intensity of the leading edge in the write shield layer 30, the magnetic field intensity (normalized magnetic field intensity) converted by using the magnetic field intensity when the thickness T4=3.0 μm as a reference (1.00) so that the fluctuations of the magnetic field intensity can be easily grasped.

TABLE 1

| | | Normalized magnetic |
|---|---|---|
| Thickness T4 (μm) | Thickness T1 (μm) | field intensity (-) |
| 3.0 | 1.0 | 1.00 |
| 2.0 | 1.0 | 1.04 |
| 1.0 | 1.0 | 1.11 |

As understood from the result shown in Table 1, the normalized magnetic field intensity gradually increases as the thickness T4 decreases. The result indicates that as the thickness T4 decreases, the magnetic flux tends to be concentrated around a portion of the air bearing surface 40 in the write shield layer 30 and the magnetic field intensity increases at the leading edge of the write shield layer 30, so that unintended overwriting of information tends to occur at the leading edge. In other words, as the thickness T4 increases, the magnetic flux is less concentrated around the portion of the air bearing surface 40 in the write shield layer 30 and, as a result, the magnetic field intensity decreases at the leading edge of the write shield layer 30. Consequently, occurrence of unintended overwriting of information at the leading edge is suppressed. It was therefore confirmed that, in the thin film magnetic head of the invention, by making the thickness T4 larger than the thickness T1, occurrence of unintended overwriting of information can be suppressed.

Subsequently, the occurrence situation of a projection defect was examined and the result shown in Table 2 was obtained. Table 2 shows the correlation between the configuration of the yoke layer 18 in the write shield layer 30 and the projection amount. The occurrence situation of a projection defect was examined by changing the thickness T1 on the side far from the air bearing surface 40 of the yoke layer 18 in three levels of 3.0 μm, 2.0 μm, and 1.0 μm while fixing the thickness T4 on the side close to the air bearing surface 40 of the yoke layer 18 in the write shield layer 30 to 3.0 μm and detecting the projection amount of the write shield layer 30, that is, the length of a projection (projection length) from the air bearing surface 40 of the write shield layer 30 expanded by the influence of heat. The projection amount of the write shield layer 30 was examined as follows. An iron cobalt nickel alloy (FeCoNi; coefficient of linear expansion=12.0×10⁻⁶/K) is used as the material of the write shield layer 30, alumina (coefficient of linear expansion=8.0×10⁻⁶/K) is used as the material of the overcoat layer 19 covering the periphery of the write shield layer 30, and the peripheral temperature (environment temperature) of the write shield layer 30 is increased by 35° C. from 25° C. to 60° C. In Table 2, as the projection amount of the write shield layer 30, to make the fluctuations in the projection amount grasped more easily, the projection amount (normalized projection amount) converted by using the projection amount when the thickness T1=3.0 μm as a reference (1.00) is shown.

TABLE 2

| | | Normalized projection |
|---|---|---|
| Thickness T4 (μm) | Thickness T1 (μm) | amount (-) |
| 3.0 | 3.0 | 1.00 |
| 3.0 | 2.0 | 0.86 |
| 3.0 | 1.0 | 0.77 |

As understood from the result shown in Table 2, the normalized projection amount gradually increases as the thickness T1 decreases. The result indicates that as the thickness T1 decreases, the thermal expansion amount of the write shield layer 30 decreases, so that projection of the write shield layer 30 from the air bearing surface 40 due to the influence of heat is suppressed. It was therefore confirmed that, in the thin film magnetic head of the invention, by making the thickness T1 smaller than the thickness T4, occurrence of a projection defect can be suppressed.

As described above, with the results obtained from Tables 1 and 2 considered, in the thin film magnetic head of the invention, the yoke layer 18 is formed so as to have the thickness T1 on the side far from the air bearing surface 40 and have the thickness T4 larger than the thickness T1 (T4>T1) by projecting only to the trailing side on the side close to the air bearing surface 40. That is, the write shield layer 30 is formed so as to have the thickness T1 on the side far from the air bearing surface 40 and have the thickness T2 larger than the thickness T1 (T2>T1) on the side close to the air bearing surface 40. With the configuration, occurrence of unintended overwriting of information can be suppressed and occurrence of a projection defect can be also suppressed. Thus, it was confirmed that stability of the recording process from the viewpoints of both of the suppression of occurrence of unintended overwriting of information and suppression of occurrence of a projection defect can be assured.

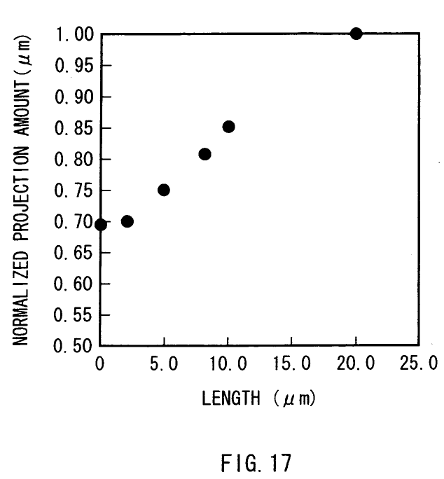

Finally, for reference sake, the occurrence situation of a projection defect based on the configuration of the yoke layer part 18B in the yoke layer 18 was examined and the result shown in FIG. 17 was obtained. FIG. 17 shows the correlation between the configuration of the yoke layer part 18B in the yoke layer 18 and the projection amount. The “horizontal axis” denotes the length (μm) of the yoke layer part 18B and the “vertical axis” denotes the normalized projection amount. The occurrence situation of the projection defect based on the configuration of the yoke layer part 18B was examined by changing the length of the yoke layer part 18B while fixing the thickness T5 of the yoke layer part 18B to 3.0 μm and fixing the width W3 to 80.0 μm and detecting the projection amount (projection length) of the write shield layer 30. The “normalized projection amount” denotes a projection amount converted by using the projection amount when the length of the yoke layer part 18B is 20.0 μm as a reference (1.00).

As understood from the result shown in FIG. 17, the normalized projection amount gradually decreases as the length of the yoke layer part 18B decreases. The result indicates that since the thermal expansion amount decreases as the length of the write shield layer 30 decreases, projection of the write shield layer 30 from the air bearing surface 40 due to the influence of heat is suppressed. It was therefore confirmed that, in the thin film magnetic head of the invention, occurrence of the projection defect can be suppressed by reducing not only the thickness T4 of the yoke layer 18 but also the length of the yoke layer part 18B.

Although the invention has been described above by the embodiment and the example, the invention is not limited to the embodiment and example but can be variously modified. Concretely, for example, in the embodiment and the example, the case of applying the invention to a shield-type head has been described. The invention is not limited to the case but may be applied to a single-magnetic-pole type head. Although the case of applying the invention to a composite thin film magnetic head has been described in the foregoing embodiment, the invention is not always limited to the case. For example, the invention can be also applied to, for example, a thin film magnetic head dedicated to recording having an inductive magnetic transducer for writing and a thin film magnetic head having an inductive magnetic transducer for recording and reproducing. Obviously, the invention can be also applied to a thin film magnetic head having a structure in which a device for writing and a device for reading are stacked in the order opposite to that of the thin film magnetic head of the embodiment.

In the embodiment and example, the case of applying the invention to the thin film magnetic head of the perpendicular recording method has been described. The invention is not always limited to the case but can be also applied to a thin film magnetic head of a longitudinal recording method.

The thin film magnetic head, head gimbals assembly, head arm assembly, magnetic recording apparatus, and the method of manufacturing the thin film magnetic head according to the invention can be applied to, for example, a hard disk drive for magnetically recording information onto a hard disk.

Obviously many modifications and variations of the present invention are possible in the light of the above teachings. It is therefore to be understood that within the scope of the appended claims, the invention may be practiced otherwise than as specifically described.

1. A thin film magnetic head comprising:
a thin film coil for generating a magnetic flux;
a magnetic pole layer extending rearward from a recording-medium-facing surface which faces a recording medium traveling in a medium travel direction and emitting the magnetic flux generated by the thin film coil toward the recording medium; and
a magnetic shield layer extending rearward from the recording-medium-facing surface on the medium travel direction side of the magnetic pole layer so that it is isolated from the magnetic pole layer by a gap layer on the side close to the recording-medium-facing surface, coupled to the magnetic pole layer via a back gap on the side far from the recording-medium-facing surface, having a first thickness on the side far from the recording-medium-facing surface, and having a second thickness larger than the first thickness by projecting in both of the medium travel direction and the direction opposite to the medium travel direction on the side close to the recording-medium-facing surface.

2. A thin film magnetic head according to claim 1, wherein the magnetic shield layer comprises:
a first magnetic shield layer part extending rearward from the recording-medium-facing surface to a first position between the recording-medium-facing surface and the back gap while being adjacent to the gap layer; and
a second magnetic shield layer part constructed as a member separate from the first magnetic shield layer part and extending rearward from the recording-medium-facing surface to at least the back gap while partially lying on the first magnetic shield layer part in the medium travel direction side of the first magnetic shield layer part.

3. A thin film magnetic head according to claim 2, wherein the first magnetic shield layer part has a third thickness,
the second magnetic shield layer part has the first thickness on the side far from the recording-medium-facing surface and a fourth thickness larger than the first thickness by projecting only to the medium travel direction side on the side close to the recording-medium-facing surface, and
the second thickness is specified by the sum of the third thickness and the fourth thickness.

4. A thin film magnetic head according to claim 3, wherein the second magnetic shield layer part comprises:
a second main magnetic shield layer part extending rearward from the recording-medium-facing surface to at least the back gap while partially lying on the first magnetic shield layer part and having the first thickness; and
a second sub magnetic shield layer part extending rearward from the recording-medium-facing surface to a second position between the recording-medium-facing surface and the back gap while partially lying on the second main magnetic shield layer part in the medium travel direction side of the second main magnetic shield layer part and having a fifth thickness, and
the fourth thickness is specified by the sum of the first thickness and the fifth thickness.

5. A thin film magnetic head according to claim 4, wherein the second position is rearward of the first position.

6. A thin film magnetic head according to claim 4, wherein the second main magnetic shield layer part and the second sub magnetic shield layer part are constructed as members different from each other.

7. A thin film magnetic head according to claim 6, wherein the second main magnetic shield layer part is made of a material having resistivity higher than that of the second sub magnetic shield layer part, and
the second sub magnetic shield layer part is made of a material having saturated magnetic flux density higher than that of the second main magnetic shield layer part.

8. A thin film magnetic head according to claim 4, wherein the second main magnetic shield layer part and the second sub magnetic shield layer part are integrally constructed.

9. A thin film magnetic head according to claim 1, wherein the magnetic pole layer emits a magnetic flux for magnetizing the recording medium in a direction orthogonal to the surface of the recording medium.

10. A head gimbals assembly comprising:
a magnetic head slider to which a thin film magnetic head is attached; and
a suspension supporting the magnetic head slider at its one end, wherein the thin film magnetic head includes: a thin film coil for generating a magnetic flux;
a magnetic pole layer extending rearward from a recording-medium-facing surface which faces a recording medium traveling in a medium travel direction and emitting the magnetic flux generated by the thin film coil toward the recording medium; and
a magnetic shield layer extending rearward from the recording-medium-facing surface on the medium travel direction side of the magnetic pole layer so that it is isolated from the magnetic pole layer by a gap layer on the side close to the recording-medium-facing surface, coupled to the magnetic pole layer via a back gap on the side far from the recording-medium-facing surface, having a first thickness on the side far from the recording-medium-facing surface, and having a second thickness larger than the first thickness by projecting in both of the medium travel direction and the direction opposite to the medium travel direction on the side close to the recording-medium-facing surface.

11. A head arm assembly comprising:
a magnetic head slider to which a thin film magnetic head is attached;
a suspension supporting the magnetic head slider at its one end; and
an arm supporting the other end of the suspension,
wherein the thin film magnetic head includes: a thin film coil for generating a magnetic flux;
a magnetic pole layer extending rearward from a recording-medium-facing surface which faces a recording medium traveling in a medium travel direction and emitting the magnetic flux generated by the thin film coil toward the recording medium; and
a magnetic shield layer extending rearward from the recording-medium-facing surface on the medium travel direction side of the magnetic pole layer so that it is isolated from the magnetic pole layer by a gap layer on the side close to the recording-medium-facing surface, coupled to the magnetic pole layer via a back gap on the side far from the recording-medium-facing surface, having a first thickness on the side far from the recording-medium-facing surface, and having a second thickness larger than the first thickness by projecting in both of the medium travel direction and the direction opposite to the medium travel direction on the side close to the recording-medium-facing surface.

12. A magnetic recording apparatus on which a recording medium and a head arm assembly are mounted,
wherein the head arm assembly comprises:
a magnetic head slider to which a thin film magnetic head according to claim 1 is attached;
a suspension supporting the magnetic head slider at its one end; and
an arm supporting the other end of the suspension, and
wherein the thin film magnetic head includes: a thin film coil for generating a magnetic flux;
a magnetic pole layer extending rearward from a recording-medium-facing surface which faces a recording medium traveling in a medium travel direction and emitting the magnetic flux generated by the thin film coil toward the recording medium; and
a magnetic shield layer extending rearward from the recording-medium-facing surface on the medium travel direction side of the magnetic pole layer so that it is isolated from the magnetic pole layer by a gap layer on the side close to the recording-medium-facing surface, coupled to the magnetic pole layer via a back gap on the side far from the recording-medium-facing surface, having a first thickness on the side far from the recording-medium-facing surface, and having a second thickness larger than the first thickness by projecting in both of the medium travel direction and the direction opposite to the medium travel direction on the side close to the recording-medium-facing surface.

13. A method of manufacturing a thin film magnetic head comprising:
a thin film coil for generating a magnetic flux;
a magnetic pole layer extending rearward from a recording-medium-facing surface which faces a recording medium traveling in a medium travel direction and emitting the magnetic flux generated by the thin film coil toward the recording medium; and
a magnetic shield layer extending rearward from the recording-medium-facing surface on the medium travel direction side of the magnetic pole layer so that it is isolated from the magnetic pole layer by a gap layer on the side close to the recording-medium-facing surface, and coupled to the magnetic pole layer via a back gap on the side far from the recording-medium-facing surface,
the method comprising a step of forming the magnetic shield layer so as to have a first thickness on the side far from the recording-medium-facing surface, and have a second thickness larger than the first thickness by projecting in both of the medium travel direction and the direction opposite to the medium travel direction on the side close to the recording-medium-facing surface.

14. A method of manufacturing a thin film magnetic head according to claim 13, wherein the step of forming the magnetic shield layer comprises the steps of:
forming a first magnetic shield layer part extending rearward from the recording-medium-facing surface to a first position between the recording-medium-facing surface and the back gap while being adjacent to the gap layer; and
forming a second magnetic shield layer part constructed as a member separate from the first magnetic shield layer part and extending rearward from the recording-medium-facing surface to at least the back gap while partially lying on the first magnetic shield layer part in the medium travel direction side of the first magnetic shield layer part.

15. A method of manufacturing a thin film magnetic head according to claim 14, wherein the first magnetic shield layer part is formed so as to have a third thickness,
the second magnetic shield layer part is formed so as to have the first thickness on the side far from the recording-medium-facing surface and to have a fourth thickness larger than the first thickness by projecting only to the medium travel direction side on the side close to the recording-medium-facing surface, and
the second thickness is specified by the sum of the third thickness and the fourth thickness.

16. A method of manufacturing a thin film magnetic head according to claim 15, wherein the step of forming the second magnetic shield layer part comprises the steps of:
forming a second main magnetic shield layer part constructing a part of the second magnetic shield layer part, extending rearward from the recording-medium-facing surface to at least the back gap while partially lying on the first magnetic shield layer part and having the first thickness; and
forming a second sub magnetic shield layer part as another part of the second magnetic shield layer part extending rearward from the recording-medium-facing surface to a second position between the recording-medium-facing surface and the back gap while partially lying on the second main magnetic shield layer part in the medium travel direction side of the second main magnetic shield layer part and so as to have a fifth thickness, and
the fourth thickness is specified by the sum of the first thickness and the fifth thickness.

17. A method of manufacturing a thin film magnetic head according to claim 16, wherein the second position is rearward of the first position.

18. A method of manufacturing a thin film magnetic head according to claim 16, wherein the step of forming the magnetic shield layer comprises:
a first step of forming the first magnetic shield layer part on the gap layer by growing a plating film;
a second step of forming the second main magnetic shield layer part so as to extend rearward from the recording-medium-facing surface to at least the back gap while partially lying on the first magnetic shield layer part and having the first thickness as a whole; and
a third step of forming the second magnetic shield layer part so as to include the second main magnetic shield layer part and the second sub magnetic shield layer part by forming the second sub magnetic shield layer part as a member different from the second main magnetic shield layer part on the second main magnetic shield layer part by growing a plating film.

19. A method of manufacturing a thin film magnetic head according to claim 16, wherein the step of forming the magnetic shield layer comprises:
a first step of forming the first magnetic shield layer part on the gap layer by growing a plating film;
a second step of forming a pre-magnetic shield layer as a preparation layer of the second main magnetic shield layer part so as to extend rearward from the recording-medium-facing surface to at least the back gap while partially lying on the first magnetic shield layer part and having the fourth thickness as a whole; and
a third step of forming the second magnetic shield layer part so as to integrally include the second main magnetic shield layer part and the second sub magnetic shield layer part by selectively etching a part on the side far from the recording-medium-facing surface of the pre-magnetic shield layer to the first thickness.
